(19) United States
(12) Patent Application Publication
(10) Pub. No.: US 2004/0233459 A1
(43) Pub. Date: Nov. 25, 2004

(54) Movement detection speckle interferometer

(76) Inventor: Anthony G. Booth, London (GB)

Correspondence Address: HARNESS, DICKEY & PIERCE, P.L.C., P.O. BOX 828, BLOOMFIELD HILLS, MI, 48303, US

(21) Appl. No.: 10/479,631

(22) PCT Filed: Jun. 7, 2002
(86) PCT No.: PCT/GB02/02696

(30) Foreign Application Priority Data
Jun. 9, 2001 (GB) 0114070.6

(51) Int. Cl. G01B 9/02

(52) U.S. Cl. 356/498

(57) ABSTRACT

A z-movement detector utilises an optical interferometer with a laser diode as a light source (301) and an optical interference detector (302) which detects changes in the speckle pattern of the light from the laser as a result of movements of a target (307) in the z-direction. Key element of the interferometer is the use of a single block of glass (318) which physically integrates the beam splitting functions and some of the reflection functions of the interferometer.

### BACKGROUND OF THE INVENTION

1. Field of the Invention

The present invention relates to movement detection apparatus and method and more particularly to the detection of movement of a target in the z-direction, i.e. towards or away from the detector as distinct from movement, such as rotational movement, or movement in the x or y directions which are normal to the axis of the detector. However, not all aspects of the invention are limited to z-axis detection.

An example of a target where it is desired to measure or detect movement in the z-direction is the end of a rod, such as a heated rod in a furnace.

It is possible to produce coherent light by means of a laser and the cost of such devices has reduced significantly In recent years due to the availability of semi-conductor lasing elements. This coherent light may be reflected by smooth reflecting surfaces, such as mirrors used in optical devices for directing the light along particular orientations. However, when coherent light is reflected from a less than perfectly smooth surface, which will be termed a rough surface herein, a human observer viewing the reflected light experiences an effect known as speckle. Furthermore, head movement while this speckle effect is being observed causes the pattern to move and it is known that the direction of speckle movement will vary between short-sighted people and long-sighted people. This effect occurs because the pattern is actually being formed by interference on the retina of the observer themselves; thus, the totality of the effect depends upon the observer who now forms part of the overall system.

A property of speckle is that the speckle pattern moves when movement occurs to the reflecting surface. Consequently, by analysing the movement of the reflected pattern it is possible to deduce certain movements of the moving object. This effect is related to the movement of the surface texture itself. When mixed with a sample of the original light the effect can distinguish movement towards and away from a detector, usually referred to as movement in the z-direction. Movement in the z-direction produces effects of a different type to the effects produced by movement in the x, y directions for example at the end of a rotating shaft. The present invention makes use of a laser and the associated speckle effect referred to above.

2. Description of the Related Art

There are a number of prior art devices and methods for detecting movement in the z-axis. However, these generally utilise relatively high precision lasers such as helium-neon (He—Ne) lasers and relatively refined high precision optical systems thus making them expensive and time-consuming to set up. It is known to construct a z-axis detector using a He—Ne laser incorporated in what is essentially an interferometer such as a Mickelson interferomter.

The purpose of the present invention is to provide a much cheaper detection arrangement which nevertheless provides an acceptable degree of accuracy in many commercial applications.

The arrangement of the present invention can also easily be upgraded in order to provide enhanced accuracy for specific commercial applications.

### SUMMARY OF THE INVENTION

According to the present invention a z-axis detector comprises:

a) a light source in the form of a diode laser;

b) an interferometer downstream of the light source;

c) a first light path exiting from the interferometer to, in use, hit the target;

d) a second light path exiting from the interferometer;

e) a third light path which is a scattering of light from the first light path after impact with the target;

f) a detector downstream of the first and third light paths; and

g) the arrangement of a) to f) being such that the detector detects the granular or speckled appearance of the light reflected from the target to produce an output signal indicative of movement of the target.

The granular or speckled appearance referred to above is a known characteristic of laser light reflected from a diffusing surface, as discussed earlier.

For example if a slightly expanded laser beam (e.g. produced by means of a simple lens) is projected onto a defusing surface such as a piece of paper then the illuminated disc on the paper appears speckled with bright and dark regions that sparkle and shimmer. The exact appearance of the grains of the scattered light will depend upon the observers position in relation to the scatterer (in this case the piece of paper) and also depend on the observers eyesight, i.e. whether it is normal, short sighted or long sighted.

For example if the observer squints the grains grow elongated. If the observer moves towards the paper the grains maintain their angular size, thus appearing smaller on the paper. If an observer who normally wears spectacles removes those spectacles then the grain pattern stays in perfect focus. Generally irrespective of the position of observation the granular pattern or speckles remain crystal clear. This is because the spatially coherent light scattered from the diffusing surface fills the surrounding region with a stationary interference pattern. At the surface the granules or speckles are exceedingly small and they increase in size with distance from the surface. At any location in space the resultant field is the superposition of many contributing scattered wavelets.

If the interference pattern (at the detector) is to be sustained then it is necessary for the scattered wavelets to have a constant relative phase determined by the optical path lengths from the scatterer to the point in question, i.e. the detector.

According to a first aspect of the present invention a comparator circuit is connected to an output of the detector and to an output from the light source so that a comparator output signal may be obtained which is indicative of the movement in the z-axis of the target.

According to a second aspect of the invention the interferometer is a variant of the Mach-Zehnder interferometer having first, second, third and fourth mirror surfaces and a first transmission/refraction surface.

According to a third aspect of the present invention the first and fourth mirror surfaces and the first transmission/refraction surfaces are provided by a single transparent block.

According to a fourth aspect of the present invention the second and third mirror surfaces are provided by an arrangement which reflects the incident light back in the opposite direction.

According to a fifth aspect of the present invention the transparent block has a first plane reflecting surface and a second plane reflecting surface, the two surfaces being substantially parallel to one another, the first plane surface forming both the first mirror and also the first transmitting/refracting surface and the second plane surface forming the fourth mirror and also a second transmitting/refracting surface, the target being downstream of the first mirror, first transmitting/refracting surface, the second mirror being downstream of the second transmitting/refracting surface and the detector being downstream of the second surface comprising the fourth mirror, a one hundred and eighty degree reflector including a single mirror downstream of a lens whereby the single mirror acts as both the second and third mirror of the Mach-Zehnder interferometer.

According to a sixth aspect of the present invention the light source comprises a diode laser.

According to a seventh aspect of the present invention the detector comprises a pin diode detector.

According to an eighth aspect of the present invention the transparent block is provided on its first surface with a light absorbing coating provided with a window which functions as a first mirror and first transmitting-refracting surface, the light absorbing coating being so dimensioned and constructed that unwanted scattered light such as that from the light source which is reflected from the inner surface of the said second surface of the transparent block will be absorbed in the coating.

For maximum light absorption the coating has a refractive index which is substantially equal to the refractive index of the transparent material forming the block.

According to a ninth aspect of the present invention the transparent material of the block comprises glass.

According to a tenth aspect of the present invention there is a base member component, a transparent block component having substantially mutually parallel first and second surfaces being mounted on the base member, a laser diode component mounted on the base member, a one hundred and eighty degree reflector component mounted on the base member and a detector diode mounted on the base member, the geometry and configuration of the aforesaid components being such that the transparent block together with the one hundred and eighty degree reflector forms a Mach-Zehnder interferometer.

The essence of the present invention is that in a detection arrangement of the kind to which the present invention relates the relatively costly optical part has a simple and relatively crude construction which is easy to set up and the relatively inexpensive electronic comparator circuit to which the detector output is connected has a relatively sophisticated construction and function.

This contrasts with a single mode or central fringe design approach where the optical part of the arrangement is relatively sophisticated and accurate and therefore expensive.

The key part of the detection arrangement of the present invention consists of the above mentioned base having mounted thereon the transparent block, the laser diode, the one hundred and eighty degree reflector and the diode detector.

The glass block as such is also a key aspect of the present invention.

### BRIEF DESCRIPTION OF THE DRAWINGS

How the invention may be carried out will now be described by way of example only and with reference with the accompanying drawings in which:

FIG. 1 is a diagrammatic representation of the known Mach-Zehnder interferometer;

FIG. 2 is a diagram similar to FIG. 1 but showing the optical principles of an arrangement according to the present invention;

FIG. 3 is a respective view of a physical embodiment of the present invention employing the optical principles shown in FIG. 2;

FIG. 4 illustrates the one hundred and eighty degree reflector in more detail;

FIG. 5 illustrates a half-wave step plate for use in the arrangement shown in FIG. 3.

FIG. 6 illustrates the electronic processor which is connected to the arrangement shown in FIG. 3; and

FIG. 7 is a diagrammatic representation of a balanced diode detector arrangement.

### BEST MODE FOR CARRYING OUT THE INVENTION

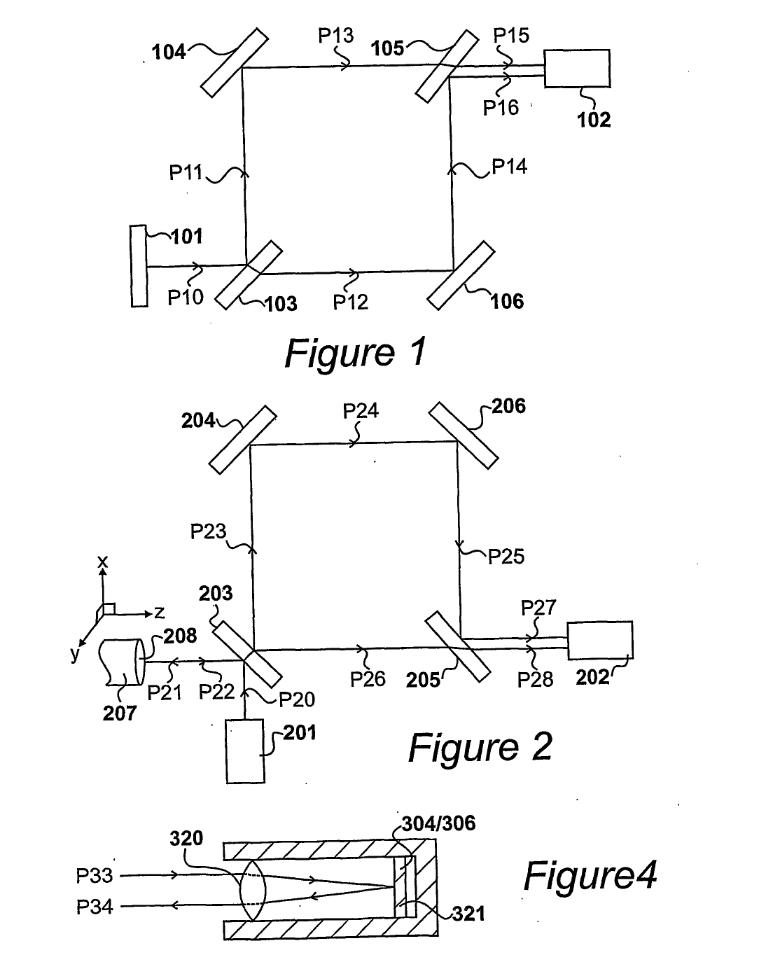

FIG. 1

This illustrates the well known Mach-Zehnder interferometer whereby a light source 101 generates a light beam P10 which is then split into two light beams P11 and P12 which merge at a detector 102 in order to form an interference pattern at the detector 102.

The initial light beam P10 is split by a first beam splitter 103 into two light beams P11 and P12. Light beam P11 is then reflected by mirror 104 to form beam P13 and then refracted by a second beam splitter 105 to form beam P15. The second light beam P12 results from refraction of the first light beam P10 by the beam splitter 103, the second light beam P12 then being reflected by the mirror 106 to form light beam P14 which is then reflected by the mirror 105 at the detector 102 to form an interference pattern.

It is known to employ as the light source 101 a ruby laser.

FIG. 2

This illustrates the basic optical characteristics of a z-axis detector constructed according to the present invention.

In FIG. 2 the beam splitter 203 corresponds to the beam splitter 103 in FIG. 1, the beam splitter 205 corresponds to the beam splitter 105 in FIG. 1, the mirror 206 corresponds to the mirror 106 in FIG. 1 and the mirror 204 corresponds to the mirror 104 in FIG. 1, the detector 202 corresponding to the detector 102 in FIG. 1.

In FIG. 2 the light source is a red light emitting diode laser 201 which corresponds to the light source 101 in FIG. 1. Diode lasers emitting other wavelengths of light, such as green, blue or ultra-violet could be employed.

The beam splitter 203 consist of a partially reflective mirror i.e. a plate which enables some of the incident light from the diode laser 201 to be reflected towards a target 207 and some to be transmitted through the partial mirror 203 towards the mirror 204.

Light incident on the target 207 is then reflected back to the first beam splitter 203 and the majority of that reflected light is transmitted through the beam splitter 203 and also through the mirror 205 (which is also a partial-mirror) to reach the detector 202 which is a PIN (Positive Intrinsic Negative) diode detector.

A small proportion of the light being reflected back from the target 207 would be reflected by the beam splitter 203 back onto the diode laser 201 and this should be avoided as the diode laser is extremely sensitive to such light. Given sufficient laser power an attenuating film placed in beam P20 can help with this. Optical isolators or a polarisation arrangement could be used but this is not preferred because of the cost. It could also be achieved by tilting the laser.

A speckle interference pattern is created at the detector 202 by the two interfering light beams P27 and P28.

The target 207 could be any item where it is desired to detect movement in the direction of the z-axis as indicated in FIG. 2. For example the target could be some form of flexible diaphragm the vibration of which it is designed to detect. Also, for example, the target could be the end of a rod which is being heated and thus expanding longitudinally along the z-axis.

The light beam P22 will thus be subjected to the variations in the position of the reflecting surface 208 along the z-axis and these variations will result in fluctuations of the speckle interference pattern when the two beams P27 and P28 combine at the PIN diode detector 202.

It is assumed that the target reflecting surface 208 is not a highly polished planar surface but has at least a small diffusing effect which will give rise to the speckle effect previously described.

The essence of the detection method of the present invention is that it utilises the speckle effect referred to earlier in relation to the interference pattern which exists at the PIN diode detector 202 instead of as in the prior art endeavouring to produce a single light spot with large interference fringes which enable sampling of the central continuous fringe in order to make a measurement.

In essence the detection method of the present invention is concerned with looking at the pattern as a whole rather than trying to extract from it a “clean” interference pattern.

This technique relies upon the statistical independence of fluctuations of separate speckle dots to achieve a difference signal between separate diodes in the detector plane.

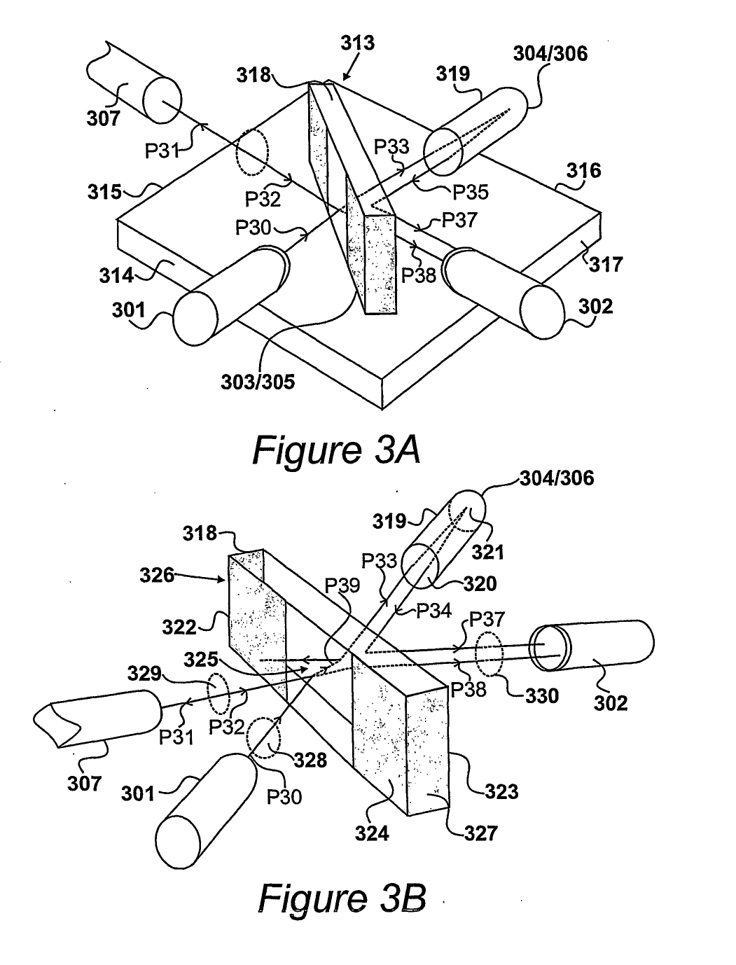

An extension to the usefulness of this device is possible allowing those special cases of system adjustment which approach the “single mode” operation as in a conventional interferometer. When operated this way the speckle dots (called fringes when they are long, regular and parallel) may grow to cover the separate diodes in the detector plane so that a difference detection is not possible. To overcome this effect a phasing plate may be introduced in the path of light beam P25. The arrangement will be described further in relation to FIG. 3 below.

In addition to the novel detection method referred to immediately above the present invention also relates to the physical construction of the Mach-Zehnder interferometer.

An embodiment of this construction will now be described with reference to FIG. 3.

FIGS. 3A and 3B

The optical components including the light source and detector of what is essentially a Mach-Zehnder interferometer are all carried by a base member 313. This base member could take various forms and be made of various materials but in this embodiment it is essentially square having a side dimension of 40 mm and the material consists of either metal or resin impregnated fibre glass of the type commonly used, for example, to manufacture printed circuit boards.

The base member 313 has four edges 314, 315, 316 and 317 respectively.

The laser diode 301 is mounted on the first edge 314 and the detector diode 302 is mounted on the fourth edge 317 each by means of a bracket (not shown) which is bonded to the base member 313 by an adhesive.

FIG. 4

The two beam splitters 303 and 305 of the interferometer are in effect incorporated into a single glass block 318 which also forms the first mirror 303 and the fourth mirror 305. The second and third mirrors 304 and 306 respectively are formed by a so-called one hundred and eighty degree device 319. The one hundred and eighty degree device 319 consists essentially of a lens 320 which focuses the light beam P33 onto a single plane mirror 321 which functions optically as the equivalent of the two mirrors 204 and 206 in FIG. 2 and reflects the beam P33 through a one hundred and eighty degrees to exit as beam P34. Instead of the arrangement shown in FIG. 4 an arrangement of two prisms could be used to reverse the beam P33 into the beam P34. A single block of glass could then be used.

The construction and optical function of the glass block 318 will now be described in more detail.

The glass block 318 has two substantially parallel plane surfaces 322 and 323. The glass of the block could be Pilkington PK7.

Although it is important that these two surfaces should be substantially optically flat a certain amount of non-parallelism is acceptable in terms of the effective functioning of the interferometer. The surface 322 and 323 should however be perpendicular to the upper surface of the base 313.

The first surface 322 is covered with a coating 324 over the majority of its surface, there however being a clear window 325 in the form of a vertical stripe at substantially its mid point.

The coating 324 also extends around the end surfaces 326 and 327 of the glass block.

The opposite second plane surface 323 is uncoated or has a wider clear stripe.

The underside surface of the glass block in contact, through an adhesive, with the base has a ground surface.

The initially incident light beam P30 on contacting the first surface 322 is split into a reflected light beam P31 and a refracted light beam P33.

The beam P31 impacts the target 307 and is reflected from it back as beam P32 to the first surface 322 of the glass block. It is then refracted through the glass block 318 and the majority of it exits the glass block as beam P38, at the second plane surface 323.

Meanwhile the majority of the refracted beam P39 exits the glass block 318 as beam P33 at the second plane surface 323 is focused by the lens 320 onto the mirror 321, reflected back as beam P34 through the lens 320 to then be incident on the second plane surface 323 of the glass block. At that point the beam P34 is reflected towards the detector 302 so that the two beams P37 and P38 interfere at the detector 302 to form the speckled pattern.

Although, as indicated earlier the majority of the beams passing though the glass block 318 exit the glass block in the manner previously described a small proportion of those beams are internally reflected within the glass block.

It is important from the point of view of the effective functioning of the interferometer that these internal beams should not be scattered from the glass block 318 to become part of the working beams P37 and P38, or return into the laser.

It is to deal with this potential problem that the coating 324 referred to earlier is provided. This coating can be any which meets the criteria of being easy to apply, being durable and having the necessary optical characteristics namely a refractive index which is close to and preferably equal to that of the glass block. It must also have enough dark pigment to absorb the light which enters it.

This coating could be polyurethane with a suspension of, for example, carbon black.

The purpose of the coating is to absorb the internally reflected light and not to re-reflect it within the glass block. The amount of carbon black is preferably only sufficient to achieve this objective, typically just enough to make the coating opaque.

The laser diode 301 is provided with a focusing lens 328 and a further focusing lens 329 is provided in relation to the target 307. Yet another focussing lens 330 is provided in association with the detector diode 302. The detector 302 operates sufficiently out of focus to spread the light over the detector diodes.

The light of beam P30 is focussed by lens 328 just upstream of the surface 322 of the glass block.

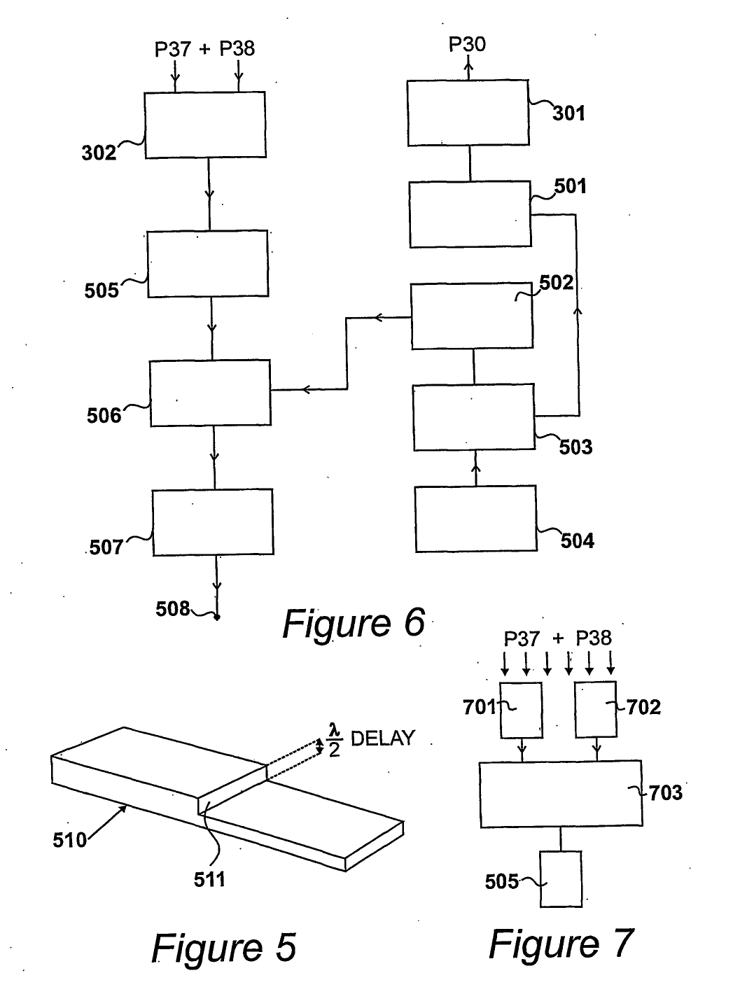

FIG. 5

In this embodiment a half-wave stepped glass plate 510 (FIG. 5) is positioned in the light path exiting from the one hundred and eighty degree reflector unit 319. The step 511 has a depth equivalent to a light path delay of a half wavelength of the red light emitted by the laser 301. Provision of the plate 510 is optional.

The interferometer just described with reference to FIG. 3 is compact, simple in construction cheap to manufacture and simple to set up.

In the arrangement shown in FIG. 3 the laser diode 301 is modulated in order to ensure that the arrangement can detect when there is indefinitely slow movement along the z-axis.

In particular the brightness of the diode laser 301 is made to fluctuate in order to modulate its frequency, the brightness fluctuation causing the temperature of the diode to fluctuate and thus vary the frequency of the light emitted by it. This in turn induces a fluctuation of optical phase between the target and reference beams arriving at the detector proportional to the difference in length of these two paths.

Furthermore if the movement in the z-axis is very slow then the detection arrangement of FIG. 3 would not be effective without modulation of the diode laser.

FIG. 6

The electronic arrangement whereby the detection signal output from the detector diode 302 and the input to the laser diode 301 are controlled/processed will now be described with reference to FIG. 6. The diode laser 301 is driven by an amplitude modulated signal from a clock source 504 through a complex programmable logic device 503 and a bandpass filter 501.

The input signal from the detector arrangement 302 is amplified at 505 and mixed at 506 with a signal synchronously related to the energising signal input to the laser 301.

The output from the mixer 506 is then amplified at 507 and output at 508 in the form of a signal in which frequency represents target velocity.

The arrangement at 505 consists of a differential low noise amplifier followed by an automatic gain control arrangement.

The input 504 to the complex programmable logic device 503 comprises a crystal controlled clock source of at 50 MHz.

The complex programmable logic device 503 divides the input from 504 digitally to give a first output at frequency f to the filter 501 and a second output at a frequency 2.5 f to the filter 502.

As mentioned earlier the input to the laser 301 is modulated to thus modulate the brightness of the laser which in turn causes temperature variations which in turn causes the frequency of the laser output to be modulated. The depth of drive modulation is about 1%, the modulation being sinusoidal.

The advantage of sinusoidal modulation is that standard filters can be used. Alternative modes of modulation could be employed such as sawtooth modulation but this would involve different detailed circuitry from the that required for the arrangement shown in FIG. 6.

FIG. 7

Although in describing the arrangement of FIG. 3 reference has been made to the detector diode 302 in fact the preferred arrangement is to have two detector diodes in the configuration shown in FIG. 7 which can be referred to as a balanced detector.

The two diode detectors 701 and 702 are arranged and operated such that variations in the brightness of the diode laser 301 cancel each other out in respect of the signals input to the two detector diodes thus ensuring that it is only the difference between the two versions of the mixture of the reference beam P37 and the target beam P38 which is measured and not the common fluctuation.

With this balanced arrangement in many cases it is possible to trim the arrangement so that it balances up to the interferometric limit thus enabling a single speckle or spot to be produced. By employing plate 510 as described above in these conditions the arrangement of FIG. 3 would perform at substantially the same level as the more optically complicated and expensive arrangements of the prior art.

The output from this balanced pair of detector diodes would be subtracted at 703 to produce an output to the amplifier arrangement indicated at 505 in FIG. 6.

1. A detector comprises:
a) a light source in the form of a diode laser;
b) an interferometer downstream of the light source;
c) a first light path exiting from the interferometer to, in use, hit the target;
d) a second light path exiting from the interferometer;
e) a third light path which is a reflection of the first light path after impact with the target;
f) a detector downstream of the first and third light paths; and
g) the arrangement of a) to f) being such that the detector detects the speckled appearance of the light reflected from the target to produce an output signal indicative of movement of the target.

2. A detector as claimed in claim 1 having a comparator circuit connected to an output of the detector and to an output from the light source so that a comparator output signal may be obtained which is indicative of the movement in the z-axis of the target.

3. A detector as claimed in claim 1 or 2 in which the interferometer is a Mach-Zehnder interferometer having first, second, third and fourth mirror surfaces and a first transmission/refraction surface.

4. A detection as claimed in any previous claim in which the first and fourth mirror surfaces and the first transmission/refraction surfaces are provided by a single transparent block.

5. A detector as claimed in any previous claim in which the second and third mirror surfaces are provided by an arrangement which reflects the incident light back in the opposite direction.

6. A detector as claimed in claim 4 in which the transparent block has a first plane reflecting surface and a second plane reflecting surface, the two surfaces being substantially parallel to one another, the first plane surface forming both the first mirror and also the first transmitting/refracting surface and the second plane surface forming both the fourth mirror and also a second transmitting/refracting surface.

7. A detector as claimed in any previous claim in which the light source comprises a diode laser.

8. A detector as claimed in any previous claim in which the detector comprises a pin diode detector.

9. A detector as claimed in claim 6 in which the transparent block is provided on its first surface with a light absorbing coating provided with a window which functions as a first mirror and first transmitting-refracting surface, the light absorbing coating being so dimensioned and constructed that light from the light source which is reflected from the inner surface of the said second surface of the transparent block will be absorbed in the coating, the coating having a refractive index which is substantially equal to the refractive index of the transparent material forming the block.

10. A detector as claimed in claim 6 or 9 in which the transparent material of the block comprises glass.

11. A detector as claimed in claim 1 in which there is a base member component, a transparent block component having substantially mutually parallel first and second surfaces being mounted on the base member, a laser diode component mounted on the base member, a one hundred and eighty degree reflector component mounted on the base member and a detector mounted on the base member, the geometry and configuration of the aforesaid components being such that the transparent block together with a one hundred and eighty degree reflector forms a Mach-Zehnder interferometer.

12. A detector substantially as hereinbefore described with reference to and as shown in FIGS. 2 to 7 of the accompanying drawings.

13. A beam splitter and reflector for use in an interferometer comprises a transparent block which has a first plane reflecting surface and a second plane reflecting surface, the two surfaces being substantially parallel to one another, the first plane surface forming both the first mirror and also the first transmitting/refracting surface and the second plane surface forming both the fourth mirror and also a second transmitting/refracting surface.

14. A beam splitter and reflector as claimed in claim 13 in which the transparent block is provided on its first surface with a light absorbing coating provided with a window which functions as a first mirror and first transmitting-refracting surface, the light absorbing coating being so dimensioned and constructed that light from the light source which is reflected from the inner surface of the said second surface of the transparent block will be absorbed in the coating, the coating having a refractive index which is substantially equal to the refractive index of the transparent material forming the block.

15. Is a beam splitter and reflector as claimed in claim 13 or 14 in which the transparent material of the block comprises glass.

16. The glass block substantially as hereinbefore described with reference to and as shown in FIG. 3B of the accompanying drawings.
